(19) United States
(12) Patent Application Publication
(10) Pub. No.: US 2002/0024889 A1
(43) Pub. Date: Feb. 28, 2002

(54) Audio information recording apparatus, audio information recording method, audio information reproducing apparatus, and audio information reproducing method

(76) Inventors: Kazuhiko Taira, Yokohama-shi (JP); Hideo Ando, Hino-shi (JP); Hideki Takahashi, Kashiwa-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/940,427

(22) Filed: Aug. 29, 2001

(30) Foreign Application Priority Data
Aug. 29, 2000 (JP) 2000-259542

(51) Int. Cl. H04B 1/20

(52) U.S. Cl. 369/1

(57) ABSTRACT

The audio information recording apparatus records audio information onto an information recording medium, with the audio information sectioned into predetermined data units (AOBUs). When soundless data and audio data are sequentially recorded as audio information onto the information recording medium, recoding is performed such that soundless data and audio data are separated from each other at a boundary between predetermined data units (AOBUs).

### CROSS-REFERENCE TO RELATED APPLICATIONS

This application is based upon and claims the benefit of priority from the prior Japanese Patent Application No. 2000-259542, filed Aug. 29, 2000, the entire contents of which are incorporated herein by reference.

### BACKGROUND OF THE INVENTION

1. Field of the Invention

The present invention relates to a system for recording/reproducing audio information on/from an information recording medium capable of recording/reproducing audio information and management information thereof, and a data structure to be recorded on an information recording medium. Particularly, the present invention relates to an audio information recording apparatus, an audio information recording method, an audio information reproducing apparatus, and an audio information reproducing method, for recording/reproducing soundless data and audio data.

2. Description of the Related Art

As is well-known, for example, in a CD (Compact Disc) or the like, a soundless part is created at the top of a track (program) and is recorded as an index #0.

If the same method as above is carried out on a recordable/reproducible disk, it is important to perform recording in consideration of facilitating not only reproduction but also editing, unlike the case of a disk dedicated to reproduction.

In this respect, with respect to an audio recording/reproducing system using a so-called magnetic disk as a recording medium, for example, developments have been made in an apparatus which performs edit processing of automatically retrieving and deleting a soundless data section created at the top part of a track when soundless data is recorded as disclosed in Japanese Patent Application KOKAI Publication No. 10-199211.

However, the technique of recording audio data such that edit processing thereof is facilitated is still being developed. It is therefore demanded to make improvements in various respects so that the technique is suitable for practical use.

In particular, this is a significant problem which influences the future developments, with respect to a so-called DVD audio disk in which audio data is recordable/reproducible with use of the DVD (Digital Versatile Disc).

### BRIEF SUMMARY OF THE INVENTION

Hence, the present invention has been made in view of the above situation and has an object of providing an audio information recording apparatus, an audio information recording method, an audio information reproducing apparatus, and an audio information reproducing method, which are capable of facilitating start of reproduction from audio data and also facilitating edit operation such as deletion of soundless data.

An audio information recording apparatus according to an embodiment of the present invention sections audio information into predetermined data units and for recording the units onto an information recording medium. The apparatus comprises a recording part for recording soundless data and audio data such that the soundless data and the audio data are separated from each other at a boundary between the predetermined data units, if the soundless data and the audio data are sequentially recorded as the audio information onto the information recording medium.

In an audio information recording method according to an embodiment of the present invention, audio information is sectioned into predetermined data units and recorded onto an information recording medium. The method comprises a recording step of recording soundless data and audio data such that the soundless data and the audio data are separated from each other at a boundary between the predetermined data units, if the soundless data and the audio data are sequentially recorded as the audio information onto the information recording medium.

An audio information reproducing apparatus according to an embodiment of the present invention performs reproduction from an information recording medium in which audio information is sectioned into predetermined data units and recorded such that soundless data and audio data are separated from each other at a boundary between the predetermined data units. The apparatus comprises a reproduction part for performing reproduction from the information recording medium in the predetermined data units, thereby to start reproduction from a top position of the audio data.

In an audio information reproducing method according to an embodiment of the present invention, reproduction is performed from an information recording medium in which audio information is sectioned into predetermined data units and recorded such that soundless data and audio data are separated from each other at a boundary between the predetermined data units. The method comprises a reproduction step of performing reproduction from the information recording medium in the predetermined data units, thereby to start reproduction from a top position of the audio data.

### BRIEF DESCRIPTION OF THE SEVERAL VIEWS OF THE DRAWING

FIG. 1 shows an embodiment of the present invention and explain a management data structure concerning audio track information recorded on an information recording medium:

FIG. 2 is a diagram for explaining a directory structure of a still picture file, an audio file, and a text file related to recordable/reproducible audio information recorded on the information recording medium in the embodiment;

FIG. 3 is a diagram for explaining the relationship between a play list and an audio object file in the embodiment;

FIGS. 4A to 4B are views for explaining screen images when a play list is created in the embodiment;

FIGS. 5A to 5B are diagrams for explaining the relationship between an original PGC and audio objects in the embodiment;

FIG. 6 is a block diagram for explaining the structure of an information recording/reproducing apparatus in the embodiment;

FIG. 7 is a flowchart for explaining operation of recording soundless data in the embodiment; and

FIG. 8 is a flowchart for explaining reproduction operation in case where a soundless data section exists in the embodiment.

### DETAILED DESCRIPTION OF THE INVENTION

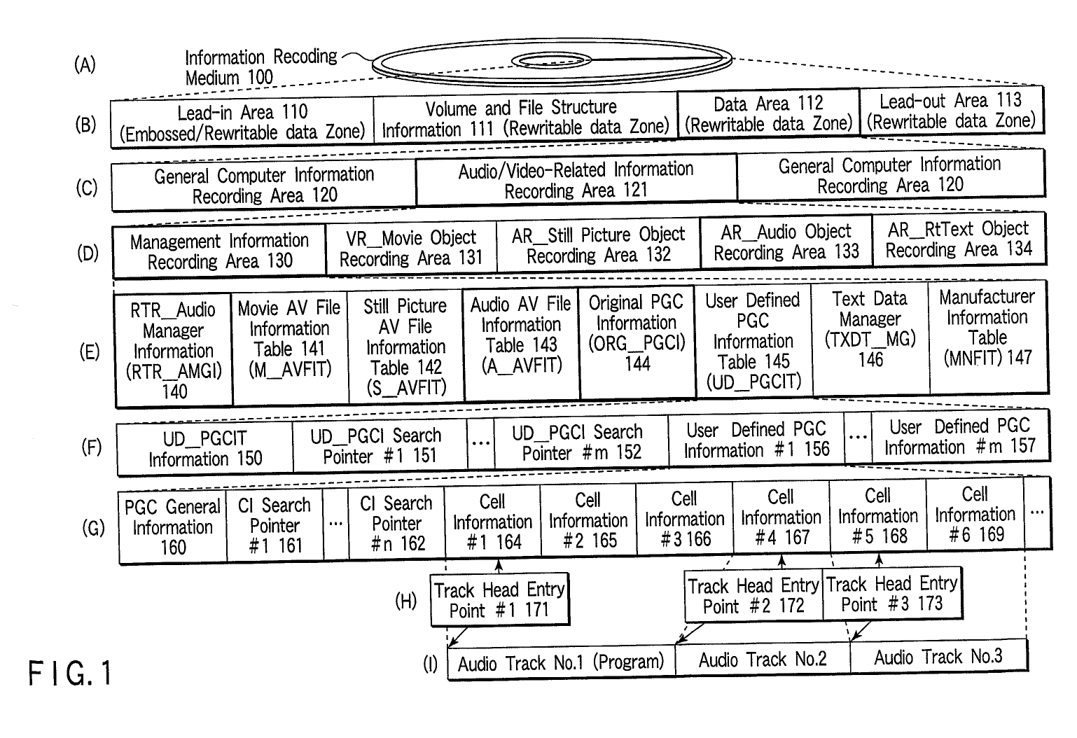

In the following, an embodiment of the present invention will be specifically explained with reference to the drawings. (A) to (I) of FIG. 1 each explain an information recording medium 100 which is rewritable and has a disk-like shape.

In the information recording medium 100, there is a data area 112 where a user can record information. The inside of the data area 112 is formatted such that a general computer information recording area 120 and an audio/video-related information recording area 121 can be mixed.

Content information items of audio and video are each called an “object”. Video content information is recorded in a VR_Movie Object recording area 131. Audio content information is recorded in an AR_Audio Object recording area 133.

According to the information recording medium 100, still picture information (still picture) can be displayed at the same time when audio information (audio object) is reproduced. In addition, real-time text information such as a lyric card or the like which changes in synchronization with audio information (audio object) can be displayed simultaneously.

The still picture information (still picture) is recorded in the AR_Still Picture Object recording area 132. The real-time text information can be recorded, buried at a part of the audio information (audio object) in the AR_Audio Object recording area 133.

The audio information (Audio Object), the still picture information (Still Picture), and real-time text information (Real Time Text) are totally called “audio-related information”.

The contents of these object information items (content information), property information, control information for display, and the like are recorded in the management information recording area 130, as shown in (D) of FIG. 1.

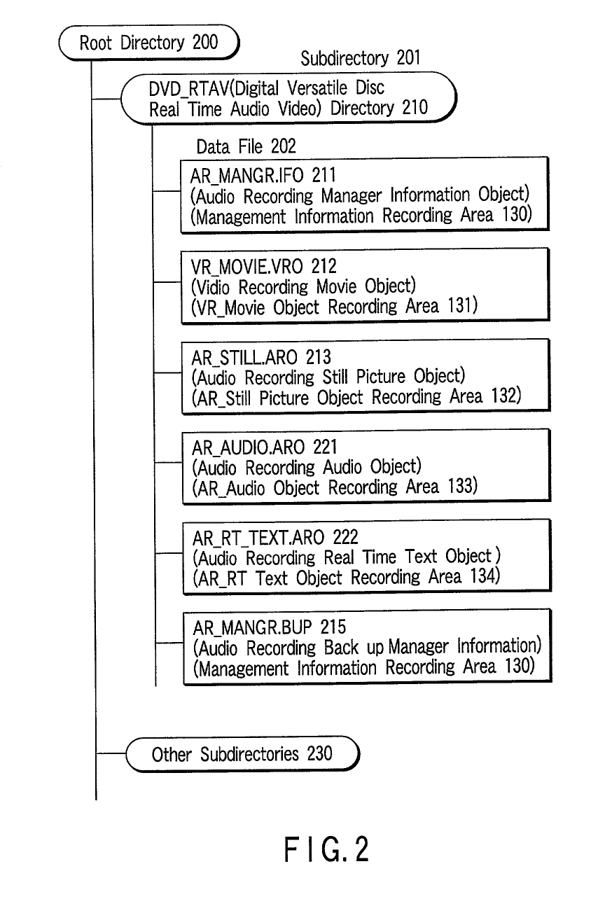

The object information (content information) is recorded in one independent file for every content of the object. As shown in FIG. 2, all audio information items (Audio Object) are recorded together in an AR_AUDIO.ARO 221 file.

All still picture information items (Still Picture) are recorded together in an AR_STILL.ARO 213 file. All real-time text information items (Real Time Text) can be recorded as a part of audio information in the AR_AUDIO.ARO 221 file.

One scene of a video picture in a video information file defined according to the video recording standard is displayed simultaneously with audio information extracted as a still picture. A video information file VR_MOVIE.VRO 212 used at this time is also recorded in the same DVD_RTAV directory 210.

Information in a management information recording area 130 which unitarily manages these object files is recorded in an AR_MANGR.IFO 211 file and an AR_MANGR.BUP 215 file as a backup file thereof.

With respect to audio-related information, the frame part of the data structure of management information to be recorded on an information recording medium 100 capable of recording and reproducing is the same as the structure of the video recording standard established by DVD FORUM, with the compatibility taken to be significant, as shown in (E) of FIG. 1.

The information indicating the reproducing procedure of audio-related information is recorded in PGC (Program Chain) Information 144 and 145, like the standard of “Part 3 VIDEO RECORDING/DVD Specifications for Rewritable/Re-recordable Discs” established in September 1999 by the DVD FORUM.

The minimum basic unit of reproducing audio-related information is called a “Cell”. The PGC (Program Chain) as a processing procedure is constructed as a sequence of cells. Management information concerning cells is recorded in Cell Information #1 164 to #6 169 recorded in the management information recording area 130.

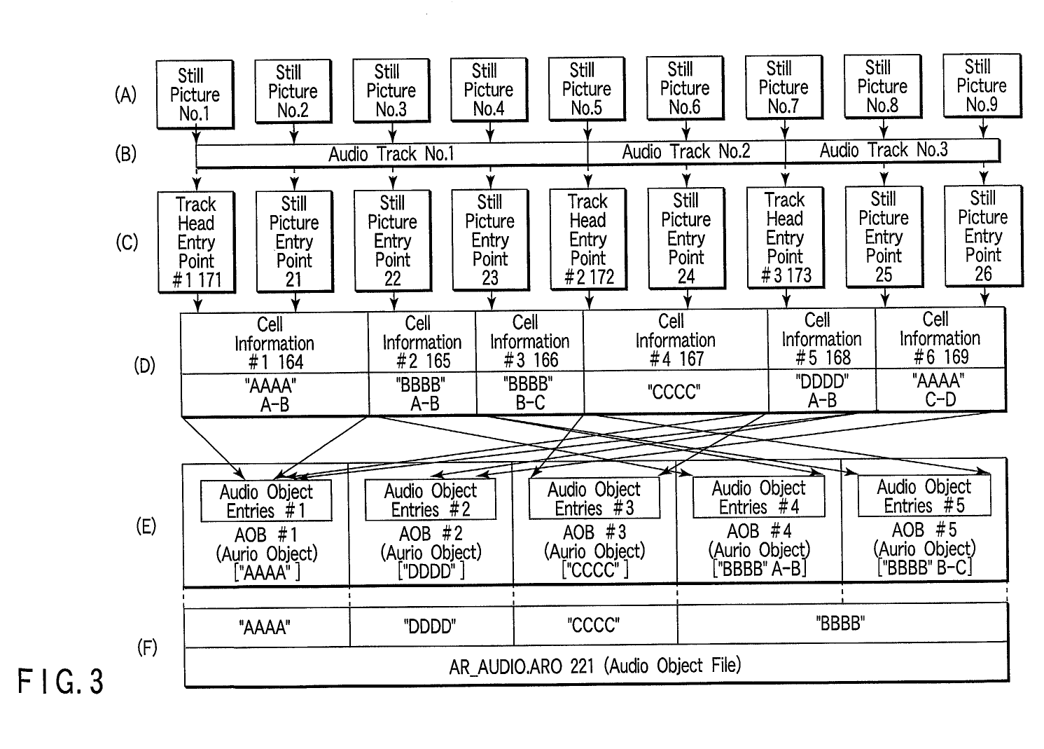

As shown in (D) of FIG. 3, information indicating which of plural items of audio information (Audio Objects) recorded in the AR_AUDIO.ARO 221 file reproduces which range of which audio information (Audio Object) is recorded in the Cell Information #1 164 to #6 169.

The procedure of reproducing audio-related information reproduced in accordance with one PGC information item is the order in which Cell Information #1 164 to #6 169 constructing the PGC Information 156 are arranged, as shown in (G) of FIG. 1.

For example, if the Cell Information #1 164 specifies a part of the audio information (Audio Object) having a track name (song name) of “AAAA”, the Cell Information #2 165 and the Cell Information #3 166 specify the audio information (Audio Object) having a track name (song name) of “BBBB”, and the Cell Information #4 167 specifies the audio information (Audio Object) having a track name (song name) of “CCCC”, as shown in (D) of FIG. 3, “BBBB” is reproduced and displayed after a part of “AAAA” is reproduced and displayed, and “CCCC” is reproduced and displayed next, in accordance with the order of arrangement of the Cell Information #1 164 to #6 169.

There are two types of information items for indicating a reproduction order, i.e., (1) information indicating a reproduction procedure in which reproduction is carried out in the order in which data is recorded on the information recording medium 100 and (2) information indicating the reproduction order which can be arbitrarily specified by a user.

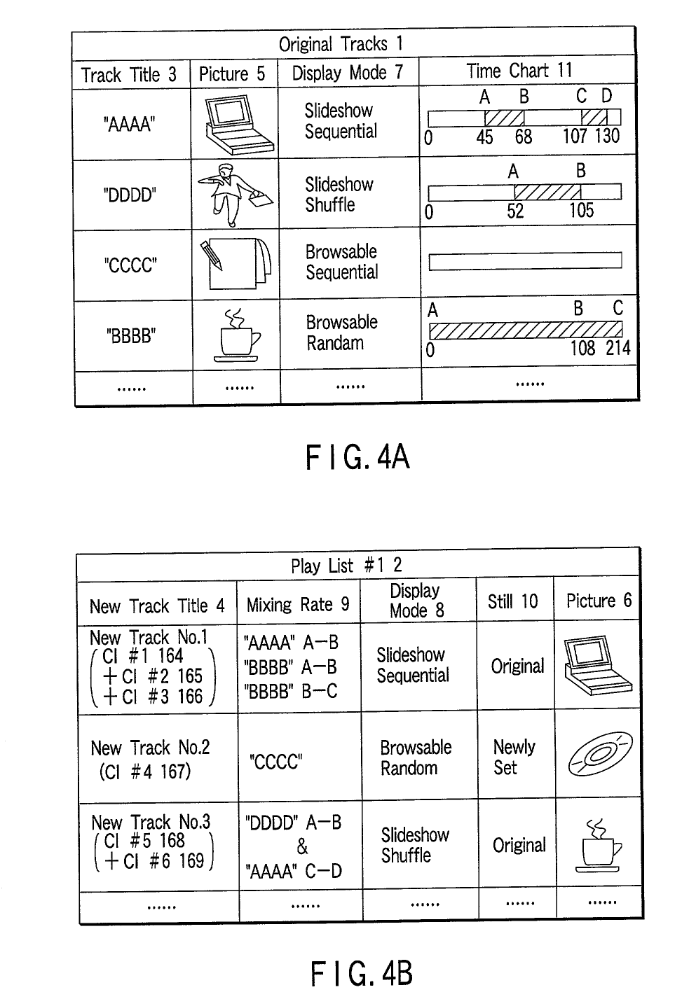

The information (1) indicating the reproducing procedure in the order in which data is recorded on the information recording medium 100 is called “Original PGC” as a name as management information, and is also called “Original Tracks” as a name for users, as shown in FIG. 4A.

The information (2) indicating the reproducing procedure which can be arbitrarily specified by a user is called “User Defined PGC” as a name as management information, and is also called “Play List” as a name for users, as shown in FIG. 4A.

Only one Original PGC exists in the information recording medium 100. A plurality of User Defined PGCs can be set in the information recording medium 100. Management information items concerning User Defined PGCs are recorded in User Defined PGC Information #1 156 to #m 157. These information items are unitarily managed within a User Defined PGC Information Table 145.

CDs, MDs (Magneto Optical Discs), and cassette tapes, for example, each has management units called tracks respectively set for songs of popular music or for movements of classic music.

When creating the Play List (User Defined PGC), for example, there is a case that a user combines a part of an original track called “A” with a part of an original track called “B”, to create a new original track called “^{C”.}

As shown in (E) of FIG. 3, one cell can specify only consecutive reproduction ranges in the AR_AUDIO.ARO 221. However, discrete ones of reproduction ranges which exist scattered in the AR_AUDIO.ARO 221 cannot be specified.

In this case, a part of an original track having a name of “A” is specified as one user defined Cell #1, a part of an original track having a name of “B” is specified as another one user defined Cell #2, and a new track having a name of “C” is defined and managed as a combination of the Cells #1 and #2. That is, the data structure is arranged such that one track is constructed by a combination of one or more cells.

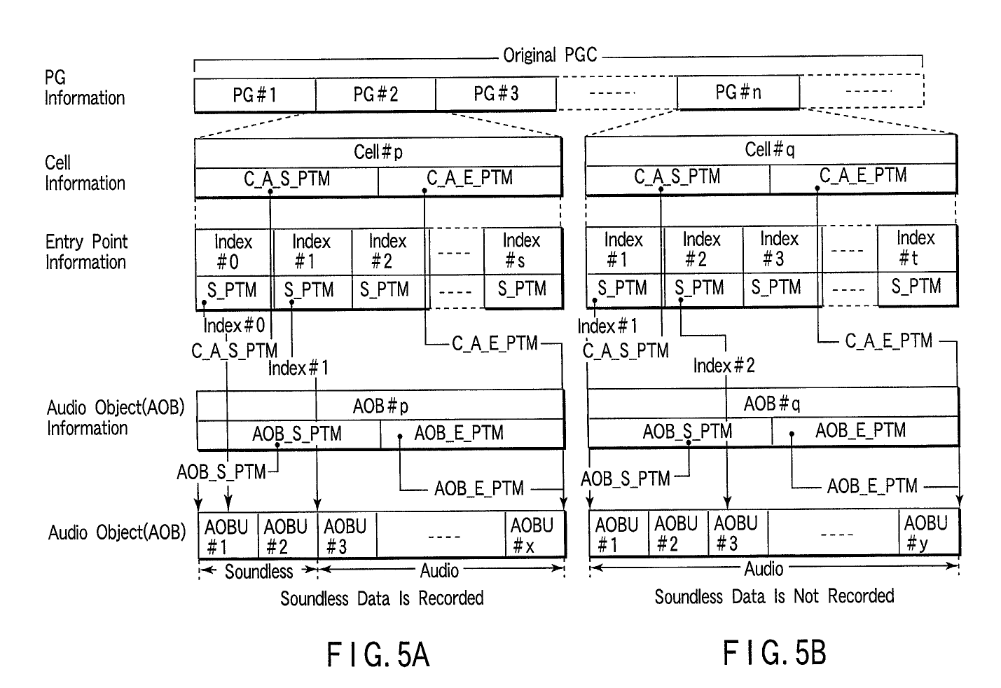

FIGS. 5A and 5B show a relationship between original PGC information as management data and audio objects as reproduction data. The original PGC information as management data includes PG information for managing a plurality of PGs (Programs). Each PG is constructed by a plurality of cells.

The cell information includes reproduction management information of corresponding reproduction data AOB. Cells correspond respectively to AOBs of reproduction data in a one-to-one relationship. A reproduction section within an AOB is specified by specifying a cell reproduction start time C_A_S_PTM and a cell reproduction end time C_A_E_PTM within the AOB reproduction time.

The AOB information is management information which manages the AOB itself of the reproduction data, and which includes AOB start and end addresses in an AR_AUDIO.ARO file, AOB start time AOB_S_PTM and end time AOB_E_PTM, and the like with respect to each AOB.

It is arranged such that a plurality of indexes can be added in correspondence with the reproduction time of a cell.

In CDs or the like, a soundless part is provided at the top of a track (program), and this part is recorded as an index #0, as is well-known.

As has been explained previously, if the same thing as described above is performed on a recordable/reproducible disk, it is important to perform recording, considering facilities not only in reproduction but also in editing, unlike the case of a reproduction-only disk.

If sound data and audio data are recorded, separated from each other, for every AOBU (Audio Object Unit) as an access unit for reproduction/editing in case of recording soundless data at the top of a PG (track) as shown in FIG. 5A, reproduction and editing of data can be carried out easily.

Therefore, in case of recording soundless data, the part of the soundless data is recorded, separated form audio data, at a boundary between AOBUs as recording/editing units. In this manner, in starting reproduction from audio data and in editing operation such as deletion of soundless data or the like are improved.

As shown in FIG. 5A, the soundless data section is expressed by the start time of index #0 (Index #0/S_PTM) indicating start of soundless data, and the start time of index #1 (Index #1/S_PTM) indicating start of audio data.

In this case, the start time of soundless data is equal to the cell reproduction start time C_A_S_PTM. The audio data section is expressed by the start time of index #1 (Index #1/S_PTM) indicating the start of audio data, and the cell reproduction end time C_A_E_PTM.

The reproduction time of one AOBU is about one second, and the maximum value of the reproduction time of soundless data is decided by the number of AOBUs recorded in one soundless data section. For example, if it is desired that a soundless data section should be 1.5 seconds, reproduction of soundless data of 2 seconds is enabled at most by recording two recording two AOBUs, as shown in FIG. SA.

Therefore, soundless data can be reproduced for 1.5 seconds by specifying reproduction start from 0.5 seconds in the middle of the AOBU #1 as the start time of index #0 (Index #0/S_PTM).

Thus, fine adjustment of the reproduction time can be achieved by determining the number of AOBU to be recorded as a soundless data section, depending on the soundless time, and by specifying a soundless section.

FIG. 5B shows a case where only audio data is recorded without soundless data. In this case, only the start time of the index #1 indicating start of audio data (Index #1/S_PTM) is indicated, and index #0 does not exist.

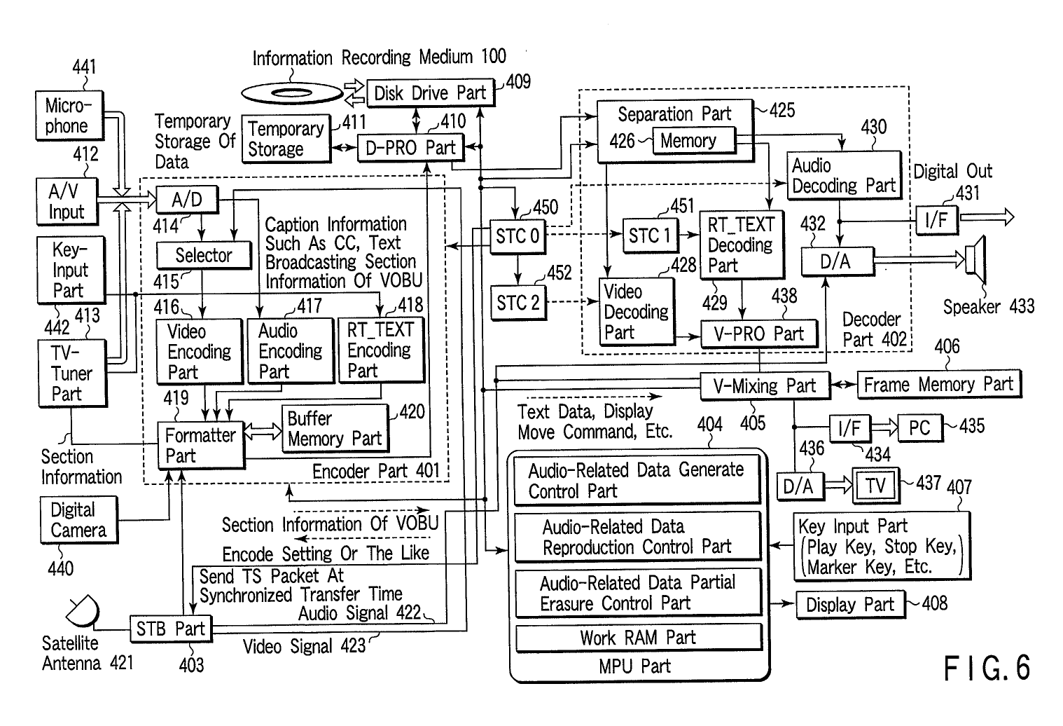

FIG. 6 shows a recording/reproducing apparatus for recoding/reproducing data with respect to an information recording medium 100. This recording/reproducing apparatus includes an A/V (Audio/Video) input part 412, a TV tuner part 413, a disk-drive part 409, a D-PRO (Data-Processing) part 410, a temporary memory part 411, an encoder part 401, an STC (System Time Clock) 0 450, an STC 2 452, a decoder part 402, I/F (Interface) parts 431 and 434, a V-mixing part (Video-mixing) part 405, a frame memory part 406, a D/A (Digital/Analogue) conversion part 436, an MPU (Micro Processing Unit) part 404, a key input part 407, and a display part 408.

Of these components, the encoder part 401 is constructed by an A/D (Analogue/Digital) conversion part 414, a selector 415, a video encoding part 416, an audio encoding part 417, an RT_TEXT encoding part 418, a formatter part 419, and a buffer memory part 420.

Further, the decoder part 402 is constructed by a separation part 425 including a memory 426, an STC 1 451, a video decoding part 428, an RT_Text decoding part 429, an audio decoding part 430, a V-PRO part 438, and a D/A conversion part 432.

Various object information inputted from various input means including the A/V input part 412 and TV tuner part 413 described above and other devices such as a microphone 414, a key input part 442, a digital camera 440, an STB (Set Top Box) 403, and the like is subjected to encoding processing at the encoder part 401, and is thereafter recorded onto the information recording medium 100 through the disk drive part 409.

Simultaneously, management information concerning the object information is generated inside the MPU part 404, and is recorded also onto the information recording medium 100 through the disk drive part 409.

When reproduction is carried out, management information recorded on the information recording medium 100 is temporarily recorded in the work RAM (Random Access Memory) part in the MPU part 404. With use of the management information temporarily stored in the work RAM part, object information of a target to be reproduced is read out and is subjected to decoding processing by the decoder part 402. Thereafter, the object information is supplied to a speaker 433, a PC (Personal Computer) 435, a TV 437, and the like.

Each of PG information, Cell information, Entry Point Information, and AOB information, which follows management information Original PGC recorded on the information recording medium 100 is read out by the disk drive part 409 and is recorded into the work RAM part of the MPU part 404.

Obtained from the information recorded into the work RAM part are the start time of index #0 indicating start of soundless data (Index #0/S_PTM), the start time of index #1 indicating start of audio data (index #1/S_PTM), the cell reproduction start time C_A_S_PTM, the cell reproduction end time C_A_E_PTM, and AOB start and end addresses in the AR_AUDIO.ARO file.

From the obtained AOB start and end addresses, AOB data recorded on the information recording medium 100 is read out. The AOB data is subjected to decoding processing at the audio decoding part 430 and is reproduced and outputted as audio data from the start time indicated at the index #0.

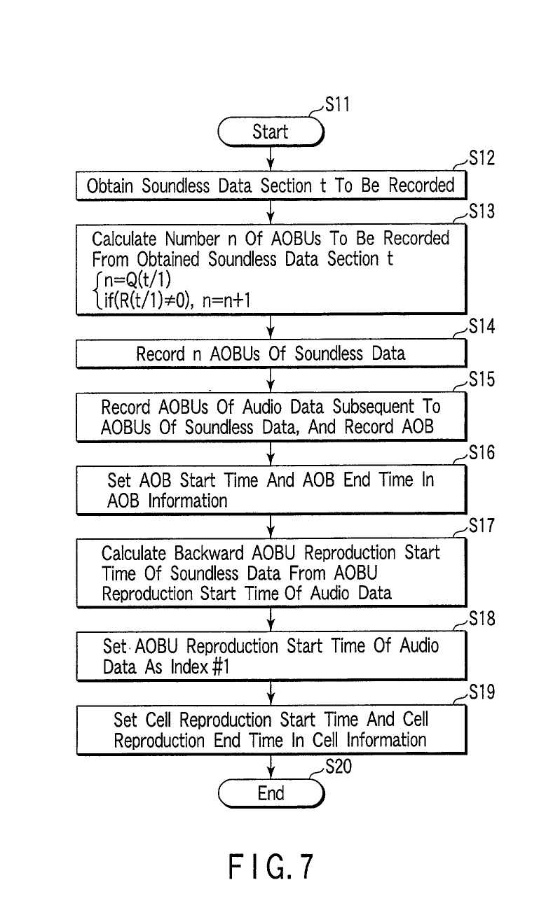

FIG. 7 shows a flowchart which summarizes the operation of setting a predetermined soundless data section on the information recording medium 100, as has been explained with reference to FIG. 5A. At first, when the operation is started (step S11), the MPU part 404 obtains a soundless data section t set by the user, for example, by means of the key input part 407, in the step S12. In case of the example explained in FIG. 5A, the soundless data section t is 1.5 seconds.

Then, in the step S13, the MPU part 404 calculates the number n of AUBUs to be recorded, based on the soundless data section t set as described above. The number n of AOBUs is determined by a quotient Q of n=t/1. If a remainder R of this division is not 0, n=n+1 is dealt with as the number n of AOBUs to be recorded. That is, supposing the example of FIG. 5A, n=1.5 sec /1 results in a quotient Q of 1 and a remainder R of 0.5. Hence, the quotient Q is added with +1 to attain 2 which is the number of AOBUs to be recorded.

Thus, the number n of AOBUs to be recorded is calculated, and then, the MPU part 404 lets the calculated n AOBUs of soundless data be recorded in the step S14. In the example of FIG. 5A, two AOBUs of soundless data are recorded.

Thereafter, the MPU part 404 records AOBUs of audio data subsequent to the recorded AOBUs of soundless data, and also records AOB, in the step S15. In case of the example of FIG. 5A, x−2 AOBUs of audio data are recorded.

Next, in the step S16, the MPU part 404 sets the AOB start time and AOB end time in the AOB information. In case of the example of FIG. 5A, AOB_S_PTM and AOB_E_PTM are set.

Thereafter, in the step S17, the MPU part 404 calculates backward the AOBU reproduction start time of soundless data from the AOBU reproduction start time of audio data, and sets the result as the index #0. Where the example of FIG. 5A is supposed, Index #0/S_PTM is set.

Further, in the step S18, the MPU part 404 sets the AOBU reproduction start time of audio data as the index #1. Where the example of FIG. 5A is supposed, Index #1/S_PTM is set.

Thereafter, in the step S19, the MPU part 404 sets the cell reproduction start time and cell reproduction end time, and ends the operation (step S20). Where the example of FIG. 5A is supposed, C_A_S_PTM and C_A_E_PTM are set.

According to the embodiment described above, the soundless data and audio data are recorded divided at boundaries between AOBUs (Audio Object Units), and a soundless data section is specified by the start time of index #0 (Index #0/S_PTM) which is equal to the cell reproduction start time C_A_S_PTM, and by the start time of index #1 (Index #1/S_PTM) which indicates the audio data start time. In this manner, it is possible to improve facilities in starting audio data reproduction at boundaries between AOBU and facilities in editing such deletion of a soundless data section and the like.

Depending on the soundless time to be inserted, the number of AOBUs to be recorded in the soundless data section is determined by shifting the reproduction start time of index #0, so that fine adjustment of soundless data reproduction time can be achieved.

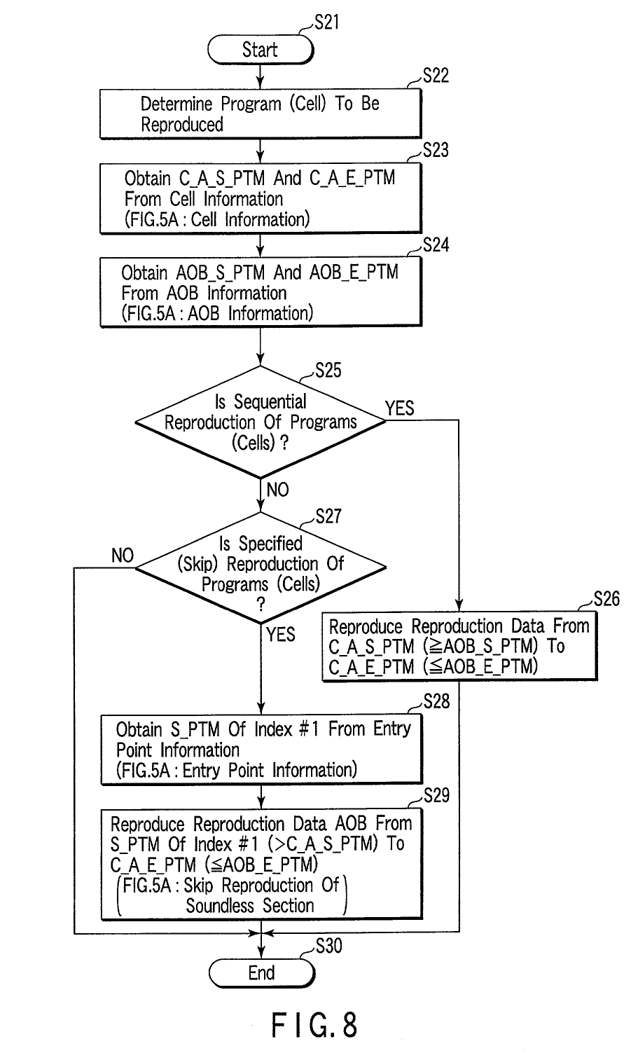

FIG. 8 shows a flowchart which summarizes the reproduction operation in case where a soundless data section exists on the information recording medium 100. At first, the operation is started (step S21). In the step S22, the program (Cell) to be reproduced is determined. In the step S23, the MPU part 404 then obtains the cell reproduction time C_A_S_PTM and the cell reproduction end time C_A_PTM from the Cell Information. In the step S24, the MPU part 404 further obtains the AOB start time AOB_S_PTM and the AOB end time AOB_E_PTM from the AOB Information.

Thereafter, in the step S25, the MPU part 404 determines whether the reproduction is sequential reproduction of Programs (Cells) or not. If it is determined to be sequential reproduction (YES), reproduction data AOB is reproduced from the cell reproduction start time C_A_S_PTM (>-AOB_S_PTM) to the cell reproduction end time C_A_E_PTM (<-AOB_E_PTM), in the step S26. The operation then ends (step S30).

If it is not determined to be sequential reproduction of Programs (Cells) (NO) in the step S25, the MPU part 404 determines whether the reproduction is so-called skip reproduction which specifies programs (Cells) or not, in the step S27. If it is not determined to be skip reproduction (NO), the operation then ends (step S30).

If it is determined to be skip reproduction (YES) in the step S27, the MPU part 404 obtains the start time of index #1 indicating the audio data start time (Index #1/S_PTM) from Entry Point Information, in the step S28. In the step S29, reproduction data AOB is reproduced from the start time S PTM (>C_A_S_PTM) of index #1 to cell reproduction end time C_A E_PTM (≦AOB_E_PTM), and the operation ends (step S30).

What is claimed is:

1. An audio information recording apparatus for sectioning audio information into predetermined data units and for recording the units onto an information recording medium, comprising
a recording part for recording soundless data and audio data such that the soundless data and the audio data are separated from each other at a boundary between the predetermined data units, if the soundless data and the audio data are sequentially recorded as the audio information onto the information recording medium.

2. An audio information recording apparatus for sectioning audio information into predetermined data units and for recording the units onto an information recording medium, comprising:
first calculation means for calculating a number of the predetermined data units where soundless data is to be recorded, from a requested soundless data section, if the soundless data and the audio data are sequentially recorded as the audio information onto the information recording medium;
first recording means for recording soundless data corresponding to the number of the predetermined data units, calculated by the first calculation means, and for subsequently recording the audio data for every predetermined data units;
second calculation means for calculating backward a reproduction start position of the soundless data, from a reproduction position of the audio data at a boundary between the soundless data and the audio data recorded by the first recording means, based on the requested soundless data section; and
second recording means for recording, onto the information recording medium, information indicating the reproduction start position of the soundless data calculated by the second calculation means and a recording start position of the soundless data, and information indicating the reproduction start position of the audio data.

3. An audio information recording method for sectioning audio information into predetermined data units and for recording the units onto an information recording medium, comprising
a recording step of recording soundless data and audio data such that the soundless data and the audio data are separated from each other at a boundary between the predetermined data units, if the soundless data and the audio data are sequentially recorded as the audio information onto the information recording medium.

4. An audio information recording method for sectioning audio information into predetermined data units and for recording the units onto an information recording medium, comprising:
a first calculation step of calculating a number of the predetermined data units where soundless data is to be recorded, from a requested soundless data section, if the soundless data and the audio data are sequentially recorded as the audio information onto the information recording medium;
a first recording step of recording soundless data corresponding to the number of the predetermined data units, calculated by the first calculation step, and of subsequently recording the audio data for every predetermined data units;
a second calculation step of calculating backward a reproduction start position of the soundless data, from a reproduction position of the audio data at a boundary between the soundless data and the audio data recorded by the first recording step, based on the requested soundless data section; and
a second recording step of recording, onto the information recording medium, information indicating the reproduction start position of the soundless data calculated by the second calculation means and a recording start position of the soundless data, and information indicating the reproduction start position of the audio data.

5. An audio information reproducing apparatus for reproduction from an information recording medium in which audio information is sectioned into predetermined data units and recorded such that soundless data and audio data are separated from each other at a boundary between the predetermined data units, comprising
a reproduction part for performing reproduction from the information recording medium in the predetermined data units, thereby to start reproduction from a top position of the audio data.

6. An audio information reproducing apparatus for reproduction from an information recording medium in which audio information is sectioned into predetermined data units and recorded such that soundless data and audio data are separated from each other at a boundary between the predetermined data units, the information recording medium recording information indicating a reproduction start position and a recording start position of the soundless data, and information indicating a reproduction start position of the audio data, and the apparatus comprising:
first reproduction means for reproducing the information indicating the reproduction start position of the audio data; and
second reproduction means for starting reproduction from a top position of the audio data, based on the information indicating the reproduction start position of the audio data reproduced by the first reproduction means.

7. An audio information reproducing apparatus for reproduction from an information recording medium in which audio information is sectioned into predetermined data units and recorded such that soundless data and audio data are separated from each other at a boundary between the predetermined data units, the information recording medium recording information indicating a reproduction start position and a recording start position of the soundless data, and information indicating a reproduction start position of the audio data, and the apparatus comprising:
reproduction part for determining a soundless data section, based on the information indicating the reproduction start position of the soundless data and the information indicating the reproduction start position of the audio data, and for reproducing the soundless data section.

8. An audio information reproducing method for reproduction from an information recording medium in which audio information is sectioned into predetermined data units and recorded such that soundless data and audio data are separated from each other at a boundary between the predetermined data units, comprising
a reproduction step of performing reproduction from the information recording medium in the predetermined data units, thereby to start reproduction from a top position of the audio data.

9. An audio information reproducing method for reproduction from an information recording medium in which audio information is sectioned into predetermined data units and recorded such that soundless data and audio data are separated from each other at a boundary between the predetermined data units, the information recording medium recording information indicating a reproduction start position and a recording start position of the soundless data, and information indicating a reproduction start position of the audio data, and the method comprising:
a first reproduction step of reproducing the information indicating the reproduction start position of the audio data; and
a second reproduction step of starting reproduction from a top position of the audio data, based on the information indicating the reproduction start position of the audio data reproduced by the first reproduction step.

10. An audio information reproducing method for reproduction from an information recording medium in which audio information is sectioned into predetermined data units and recorded such that soundless data and audio data are separated from each other at a boundary between the predetermined data units, the information recording medium recording information indicating a reproduction start position and a recording start position of the soundless data, and information indicating a reproduction start position of the audio data, and the method comprising:
a reproduction step of determining a soundless data section, based on the information indicating the reproduction start position of the soundless data and the information indicating the reproduction start position of the audio data, and of reproducing the soundless data section.
